(19) United States
(12) Patent Application Publication
(10) Pub. No.: US 2008/0302777 A1
(43) Pub. Date: Dec. 11, 2008

(54) Glow plug and method of manufacturing the same

(75) Inventor: Ikuya Ando, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/896,548

(22) Filed: Sep. 4, 2007

(30) Foreign Application Priority Data
Oct. 2, 2006 (JP) 2006-270529

(51) Int. Cl. F23Q 7/22; H05B 3/00

(52) U.S. Cl. 219/270; 29/611

(57) ABSTRACT

A glow plug and related manufacturing method are disclosed. The glow plug includes a heating section for heating a combustion chamber of an engine for promoting an ignition. The heating section includes a ceramic heating element developing a heat when applied with electric power, a ceramic insulating support body embedded with the heating element, and a pair of lead wires connected to the heating element and having terminal portions exposed to a surface of the insulating body. The heating element has a positive temperature coefficient of resistance and includes: (a) initial resistance R20 equal to or greater than 0.3Ω and equal to or less than 0.65Ω; (b) heating resistance R1200 equal to or greater than 0.7Ω and equal to or less than 1.3Ω; and (c) temperature coefficient of resistance R1200/R20 equal to or greater than 2.0 and equal to or less than 4.0.

### CROSS REFERENCE TO RELATED APPLICATIONS

This application is related to Japanese Patent Application No. 2006-270529, filed on Oct. 2, 2006, the content of which is hereby incorporated by reference.

### BACKGROUND OF THE INVENTION

1. Technical Field of the Invention

The present invention relates to glow plugs for use in internal combustion engines such as diesel engines and, more particularly, to a glow plug for preheating a combustion chamber of an internal combustion engine to promote an ignition of an air fuel mixture.

2. Description of the Related Art

In general, glow plugs have heretofore been widely used in diesel engines and each glow plug has a heating section exposed in a combustion chamber for improving startability of the engine. When applied with electric power, the heating section develops a heat thereby heating the inside of the combustion chamber for assisting an ignition.

In recent years, attempts have heretofore been made to use glow plugs each including a heating element with a large temperature coefficient of resistance to achieve a high rate of temperature increase with a view to achieving a rapid heating capability during a startup of the engine.

One of these glow plugs is disclosed in, for instance, Japanese Patent Application Publication No. 2004-245103. With this related art, the glow plug includes a heating element, having a large temperature coefficient of resistance with R1/R2>2 where R1 represents a resistance of the heating element at a temperature of 1200° C. and R2 represents a resistance of the heating element at a temperature of 20° C., which improves a rate of rapid heating capability.

Another one of these glow plugs is disclosed in, for instance, U.S. Patent Application Publication No. 2006/0049163. With this related art, the glow plug includes a resistance-heating heater with R1000/R20 that represents a ratio of an electrical resistance R1000 at a temperature of 1000° C. to an electrical resistance R20 at a temperature of 20° C.

Further, with a view to attaining not only increased ignitability of the engine during a startup thereof but also improved stability of the engine after startup thereof and increased performance of purifying exhaust gases, there has been a glowing demand on an after-glow with the glow plug supplied with electric power not only during the startup of the engine but also after the startup of the engine.

In such a case, with a view to reducing a load of an electric power supply as low as possible while more accurately controlling a temperature of the glow plug depending on an operating state of the engine, an attempt has been made to controllably supply electric power to the glow plug using a switching circuit in place of using related art electromagnetic relays arranged to be opened or closed for controlling the supply of electric power to the glow plug.

With the glow plug disclosed in, for instance, U.S. Patent Application Publication No. 2006/0049163, a PWM (Pulse Width Modulation) control is employed to execute a control of electric power to be supplied to the glow plug. For the purpose of protecting the switching circuit, the resistance-heating heater with the large temperature coefficient of resistance and a rush current suppressing resistor with a small temperature coefficient of resistance are connected in series and the PWM control is performed with a duty cycle primarily determined in accordance with an applied voltage of the resistance-heating heater.

However, with the glow plug employed the related art heating element with the large temperature coefficient of resistance with a view to achieving a further high-temperature effect on a glow temperature for improving stabilized startup of the engine, a need arises for a battery to have an increased capacity. That is, the use of the heating element having a low initial resistance and large temperature coefficient of resistance results in an increase in rush current. Thus, the battery capacity of the related art battery is insufficient in providing electric power for a starter of the engine to be driven, causing a fear to arise with an unsuccessful result in startup.

Further, although the use of the heating element having the low initial resistance and large temperature coefficient of resistance enables a reduction in rush current, a heating resistance extremely increases. This causes the related art battery to be short in available electric power, resulting in a fear with no consequence in reaching an adequate heating temperature.

Furthermore, the PWM control allows a stabilized root-mean-square voltage to be applied to the plug with no adverse affect resulting from fluctuation in battery voltage. However, the root-mean-square voltage is lower than the battery voltage being directly applied to the glow plug. Therefore, for the glow plug to keep the same heat value as that applied in the related art method, a need arises to use a low rated glow plug including a heating element with low resistance, resulting in an increase in rush current.

### SUMMARY OF THE INVENTION

The present invention has been completed with the above view in mind to address antinomy tasks for suppressing rush current and achieving an increased high-temperature rate in heating temperature and has an object to provide a glow plug, having excellent rate of heating capability and is capable to be heated at a high temperature even with the use of an electric power supply with a limited capacity, and a method of manufacturing a glow plug to achieve such operating characteristics.

To achieve the above object, a first aspect of the present invention provides a glow plug for use in an engine to heat a combustion chamber. The glow plug comprises a heating section including: a ceramic heating element operative to develop a heat when supplied with an electric power; a ceramic insulating support body carrying thereon the ceramic heating element; and a pair of lead wires, supported with the ceramic insulating support body, which have external ends exposed to a surface of the ceramic insulating support body for supplying the electric power to the heating element. The heating element has a positive temperature coefficient of resistance and lies in a region satisfying the relationship expressed as parameters including: (a) an initial resistance R20 equal to or greater than 0.3% and equal to or less than 0.65Ω; (b) a heating resistance R1200 equal to or greater than 0.7% and equal to or less than 1.3Ω; and (c) a temperature coefficient of resistance R1200/R20 equal to or greater than 2.0 and equal to or less than 4.0, where the initial resistance R20 represents a resistance at a temperature of 20° C., the heating resistance R1200 represents a resistance at a temperature of 1200° C., and the temperature coefficient of resistance R1200/R20 represents a ratio between the heating resistance R1200 and the initial resistance R20.

With the glow plug of the first aspect of the present invention, even when applied with a maximal voltage of 13.5V, rush current to the glow plug can be minimized to a level less than 45 A. This enables a reduction in power consumption per one unit of the glow plug to a value lower than 70 W, while enabling the heating element to have a heating temperature at a level of 1200° C. even when applied with a root-mean-square voltage of 7V.

With the glow plug of the present embodiment, the heating element may preferably have a surface temperature above 1100° C., when applied with a rated voltage, which is measured with a radiation thermometer with a radiation rate of E=1 and a measuring circle of φ0.5.

With the glow plug of such a structure, it becomes possible to adequately heat the combustion chamber, thereby enabling stabilized ignitability to be obtained.

With the glow plug of the present embodiment, the heating element may preferably have an effective area exceeding a length of 5 mm from a distal end of the heating element wherein the surface temperature of the heating element exceeds a temperature of 1100° C. when applied with the rated voltage.

With the glow plug of such a structure, the heating element has a protruding portion, exposed to the combustion chamber, which is mostly above 1100° C. This enables the combustion chamber to be effectively heated up to maintain further stabilized ignitability.

With the glow plug of the present embodiment, the heating element may be preferably made of ceramic composed of a principal component of silicon nitride and including at least one kind of tungsten carbide and molybdenum bisilicate and at least one kind of silicon carbide, rhenium and molybdenum.

With the glow plug of such a composition, adjusting a blending ratio of tungsten carbide or molybdenum bisilicate and silicon carbide, rhenium or molybdenum enables the initial resistance R20, the heating resistance R1200 and the temperature coefficient of resistance R1200/R20 to be set to given values.

With the glow plug of the present embodiment, the insulating support body may be preferably made of ceramic composed of a principal component of silicon nitride and including molybdenum bisilicate.

With the glow plug of such a composition, the heating element is made of the same principal component of silicon nitride as that of the insulating support body, enabling a reduction in difference in thermal expansion.

With the glow plug of the present embodiment, the heating section may further comprise an electronic control unit for supplying a pulse signal depending on a status of the engine, and a glow plug drive unit including switching circuits for controllably turning on and off the glow plug in response to the pulse signal delivered from the electronic control unit, wherein the electronic control unit regulates a duty cycle of the pulse signal to apply a root-mean-square voltage to the glow plug in a pulse width modulation for thereby controlling a temperature of the glow plug.

With the glow plug of such a structure, a stabilized root-mean-square voltage can be applied to the glow plug through PWM control regardless of fluctuation in output voltage of an electric power supply.

With the glow plug of the present embodiment, the engine may be preferably set to have a compression ratio ε less than a value of 16.

With the glow plug of such a structure, even with the engine having a low compression ratio, the presence of the glow plug having a heating temperature above 1100° C. achieves an ignition and startup in a highly reliable manner.

Accordingly, with the engine set to the compression ratio less than 16, NOx emission can be minimized, while enabling remarkable reduction in engine noise and vibrations.

A second aspect of the present invention provides a method of manufacturing a glow plug for use in an engine to heat a combustion chamber. The method comprises the steps of: preparing a green ceramic heating element; placing a power supply lead wire, having a power supply terminal, and a grounding lead wire, having a grounding terminal, in the green ceramic heating element; forming a green ceramic insulating support body so as to cover the green ceramic heating element and the power supply lead wire and the grounding lead wire; firing the green ceramic insulating support body to obtain the fired ceramic insulating support body carrying thereon a heating element operative to develop a heat when applied with an electric power through the power supply lead wire; grinding the fired ceramic insulating support body to form a ceramic insulating support body with the power supply terminal and the grounding terminal exposed to a surface of the ceramic insulating support body; and assembling the ceramic insulating support body to a housing body to form the glow plug with the power supply terminal of the heating element connected to an external power supply terminal in a manner electrically insulated from the housing body while electrically connecting the grounding terminal of the heating element to the housing body to be grounded to the engine. The heating element has a positive temperature coefficient of resistance and lies in a region satisfying the relationship expressed as parameters including: (a) an initial resistance R20 equal to or greater than 0.3Ω and equal to or less than 0.65Ω; (b) a heating resistance R1200 equal to or greater than 0.7Ω and equal to or less than 1.3Ω; and (c) a temperature coefficient of resistance R1200/R20 equal to or greater than 2.0 and equal to or less than 4.0, where the initial resistance R20 represents a resistance at a temperature of 20° C.; the heating resistance R1200 represents a resistance at a temperature of 1200° C.; and the temperature coefficient of resistance R1200/R20 represents a ratio between the heating resistance R1200 and the initial resistance R20.

With the method of manufacturing a glow plug according to a second aspect of the present invention, the glow plug can be manufactured on mass production in a highly reliable manner. The glow plug has rush current that is minimized to a level less than 45 A even when applied with a maximal voltage of 13.5V. This enables a reduction in power consumption per one piece of the glow plug to a value lower than 70 W, while enabling the heating element to have a heating temperature at a level of 1200° C. even when applied with a root-mean-square voltage of 7V.

### BRIEF DESCRIPTION OF THE DRAWINGS

FIG. 1 is a fragmentary cross sectional view showing a glow plug of a first embodiment according to the present invention under a structure mounted on an engine head.

FIG. 2 is a circuit structural diagram for the glow plug of the first embodiment shown in FIG. 1.

FIG. 3 is a is a graph showing temperature distributions on surfaces of heating sections of the glow plug of the present embodiment and a glow plug of a Comparative Example.

FIG. 4 is a is a graph showing differing temperature coefficients of resistance of the glow plug of the present embodiment and glow plugs of Comparative Examples.

FIG. 5 is a is a graph showing an optimum region of resistances of heating elements of various Examples used in the glow plug of the present embodiment shown in FIG. 1.

FIGS. 6A to 6C are graphs showing effects when increasing a ratio of tungsten carbide in the relation between silicon nitride and tungsten carbide while showing the relationships between various resistances and blending ratios of WC in weight %.

FIG. 6A shows variation in initial resistance R20, FIG. 6B variation in heating resistance R1200 and FIG. 6C variation in temperature coefficient of resistance R1200/R20.

FIGS. 7A and 7B are graphs showing effects when increasing a ratio of tungsten carbide in the relation between silicon nitride and silicon carbide with FIG. 7A showing variations in initial resistance R20 and heating resistance R1200 and FIG. 7B variation in temperature coefficient of resistance R1200/R20.

FIGS. 8A to 8C are graphs showing effects when increasing a ratio of silicon carbide in the relation between silicon nitride and silicon carbide (SiC) while showing the relationships between various resistances and blending ratios of SiC in weight %. FIG. 8A shows variation in initial resistance R20, FIG. 8B variation in heating resistance R1200 and FIG. 8C variation in temperature coefficient of resistance R1200/R20.

FIG. 9 is a ternary phase diagram showing three constituents in blending ratios of Examples 1 to 4 shown in Table 2 and Comparative Examples 1 to 5.

FIG. 10 is a flowchart showing a general outline of a method of manufacturing the glow plug according to the present invention.

FIG. 11 is an enlarged cross sectional view of a part of a glow plug of a second embodiment according to the present invention.

### DETAILED DESCRIPTION OF PREFERRED EMBODIMENTS

Now, glow plugs of various embodiments according to the present invention and a method of manufacturing a glow plug according to the present invention are described below in detail with reference to the accompanying drawings. However, the present invention is construed not to be limited to such embodiments described below and technical concepts of the present invention may be implemented in combination with other known technologies or the other technology having functions equivalent to such known technologies.

In the following description, like reference characters designate like or corresponding component parts throughout the several views. Also in the following description, it is to be understood that such terms as “base end portion”, “leading end portion”, “intermediate portion”, “axial” and the like are words of convenience and are not to be construed as limiting terms.

### First Embodiment

Now, a glow plug 1 of a first embodiment according to the present invention is described below in detail with reference to a structure under which the glow plug 1 is mounted on an engine head 2.

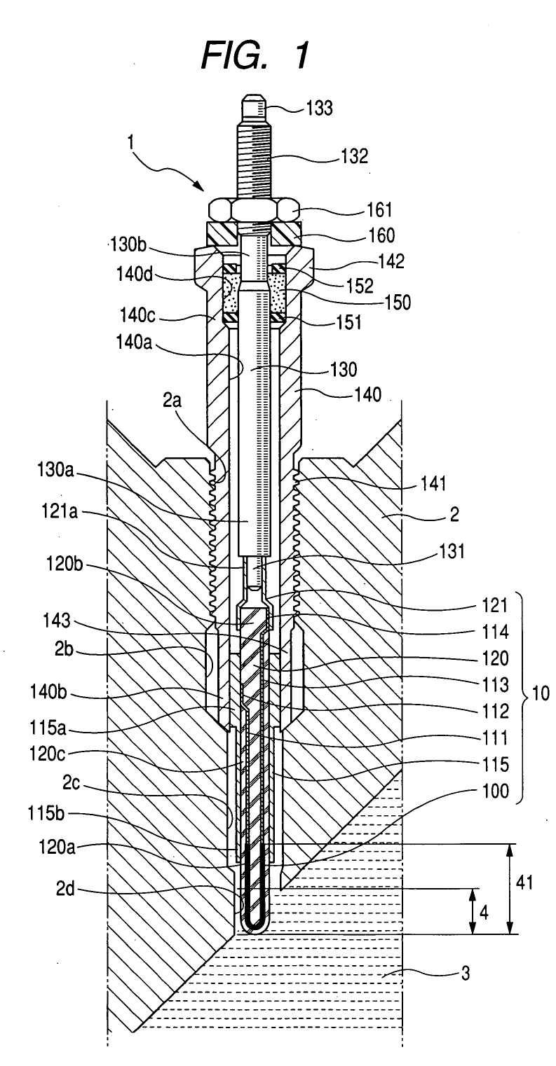

As shown in FIG. 1, the glow plug 10 is suitably applied to, for instance, the engine head 2 of an automotive engine for each cylinder to preheat a combustion chamber 3 of the engine for promoting in ignition and combustion of air fuel mixture on or after startup of the engine.

In particular, the engine head 2 has a threaded bore 2a, a large-diameter intermediate bore 2b, a small-diameter bore 2c and an end bore 2d, which are coaxially formed in connection to the combustion chamber 3.

The glow plug 1 includes a housing 140 having an intermediate portion formed with a threaded portion 141. The threaded portion 141 of the housing 140 is screwed into the threaded bore 2a of the engine head 2 to be fixedly mounted thereon. The housing 140 has an axially extending internal bore 140a. Under such a state, the housing 140 has a leading end portion 140b for internally supporting a heating section 10. The heating section 10 has a leading end portion 10a protruding into the combustion chamber 3 to allow an effective heating temperature area to be exposed to the combustion chamber 3.

The heating section 10 includes a heating element 100, a grounding lead wire 111 and power supply lead wire 113, an insulating support body 120 embedded with the grounding lead wire 111 and the power supply lead wire 113 in electrically insulating capability, and a metallic sleeve member 115, having a base end portion 115a fixedly supported with the leading end portion 140ab of the housing 140, which internally supports the insulating support body 120.

The heating element 100 is made of electrically conductive ceramic operative to develop a heat upon receipt of electric power and formed in a leading end portion 120a of the insulating support body 120 in a substantially U-shape configuration with a total length 41 of approximately, for instance, 12 mm. The heating element 100 has one end connected to the grounding lead wire 111 and the other end connected to the power supply lead wire 113.

The grounding lead wire 111 has a grounding terminal 112 exposed to an outer peripheral surface of the insulating support body 120 at an intermediate portion thereof 120c in electrical contact with the metallic sleeve member 115 at the base end portion 115a thereof.

The power supply lead wire 113 has a power supply terminal 114 extending through the base end portion 120b of the insulating support body 120 and exposed to the outer periphery of the insulating support body 120 at the base end portion 120b thereof, that is, at a position apart from the metallic sleeve member 115. The power supply terminal 114 is connected to an intermediate power supply connecting rod 130 through a connecting cap 121.

The connecting cap 121 is made of electrically conductive material such as, for instance, stainless steel or the like and formed in a stepped cylindrical sleeve-like configuration.

The heating element 100 is embedded in the leading end portion 120a of the insulating support body 120 in an effective area spaced from an end face of a leading end 115b of the metallic sleeve member 115 by a distance of more than 5 mm to be exposed to the combustion chamber 3.

The intermediate power supply connecting rod 130 is made of electrically conductive metallic material such as, for instance, carbon steel or the like and formed in a bar-like configuration. The intermediate power supply connecting rod 130 has a leading end 130a, formed with a small-diameter cap-fitting segment 131 to which a small-diameter base end 121a of the connecting cap 121 is press fitted in a fixed place, and a base end portion 130b formed with a threaded portion 132 and an external power supply terminal 133.

The housing 140 is made of electrically conductive metallic material such as iron steel (that is, for instance, S25C) and formed in a substantially cylindrical configuration formed with the internal bore 140a. The leading end 140b of the housing 140 plays a role as an element holder portion 143. The threaded portion 141 is formed on an outer circumferential periphery of the housing 140 at an intermediate area thereof and screwed into the threaded bore 2a of the engine head 2 to be tightened thereto. The housing 140 has a base end portion 140c having an outer periphery formed with the tightening hexagonal head 142 with which a tightening tool is engaged in mounting step.

The heating section 10 is coupled to the element holder portion 143 by brazing at the base end portion 115a of the metallic sleeve member 115. The base end portion 130b of the intermediate power supply connecting rod 130 is internally supported with the base end portion 140c of the housing 140 in a fixed place by means of axially spaced insulating seal members 151, 152 between which a sealant 150 such as, for instance, glass or the like is filled. A nut 161 is screwed onto the threaded portion 132 of the intermediate power supply connecting rod 130. Thus, the base end portion 130b of the intermediate power supply connecting rod 130 is tightly fixed to the base end portion 140c of the housing 140.

The grounding lead wire 111 has the grounding terminal portion 112 ended at the base end portion 115a of the metallic sleeve member 115 on an inner peripheral wall thereof and electrically connected thereto by brazing. Thus, the grounding lead wire 111 can be electrically connected to the engine head 2 via the metallic sleeve member 115 and the housing 140 in a grounded state.

Meanwhile, the power supply lead wire 113 is electrically connected to the intermediate power supply connecting rod 130 via the connecting cap 121, making it possible to supply electric power to the heating element 100.

The heating element 100 has a total length as high as 12 mm with the leading end portion 120a of the insulating support body 120 being exposed from an end face of the metallic sleeve member 115 by a length of more than 5 mm. This allows the heating element 100 to have a surface temperature higher than a value of more than, for instance, 1100° C. in a range greater than 5 mm when applied with electric power.

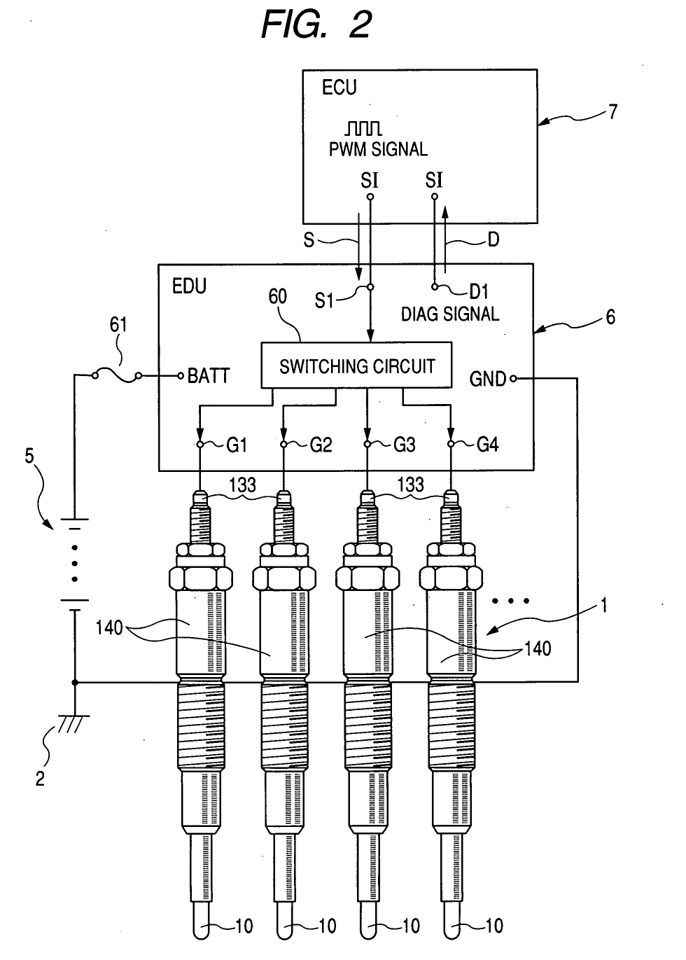

FIG. 2 is a circuit structural diagram for the glow plugs 1 of the present invention under a condition applied to a four-cylinder engine.

With the glow plugs 1 tightly screwed onto the engine head 2, the glow plugs 1 are grounded to the engine head 2. Meanwhile, the external power supply terminals 133 of the glow plugs 1 are connected to an electric drive unit (EDU) 6.

An electric power source 5 is composed of a battery 5 or a vehicle alternator (not shown). The electric power source 5 has a negative terminal grounded to the engine head 2 and a positive terminal connected to a terminal BATT of the EDU 6 via a glow fuse 61, playing a role as an electric power supply for the glow plugs 1.

The EDU 6 is connected to an electronic control unit (ECU) 7 to receive PWM (Pulse Width Modulation) signals S therefrom through terminals SI while transmitting a self-diagnosis (DIAG) signal to the ECU 7 through terminals DI. Each of the PWM signals S has a duty cycle varying depending on fluctuation in voltage of the electric power supply 5 and operating states of the engine. The EDU 6 includes a switching circuits 60 having an input for receiving the PWM signals S and outputs connected to the glow plugs 1 through terminals G1 to G4.

Upon receipt of the PWM signals S delivered from the ECU 7, the switching circuit 60 of the EDU 6 is controllably opened or closed for controlling the supply of electric power to the glow plugs 1.

A PWM control varies rates of time intervals for which the switching circuit is opened or closed, thereby controlling an output voltage. When this takes place, a duty ratio is regulated such that the lower the output voltage, the longer will be the opening time interval of the switching circuit and the higher the output voltage, the shorter will be the opening time interval of the switching circuit. This enables the glow plugs 1 to be applied with a root-mean-square voltage maintained at a fixed level at all times regardless of fluctuation in voltage of the electric power supply 5.

In addition, the EDU 6 is operative to diagnose heating states of the glow plugs 1 mounted on the engine head 2 for respective cylinders to deliver the DIAG signals D to the ECU 7. Thus, the ECU 7 can monitor the heating states of the respective glow plugs 1 in response to the DIAG signals D to generate the PWM signals S with varying duty cycles. Thus, the respective glow plugs 1 can be maintained at optimum heating temperatures, respectively.

With a low compression ratio engine having a compression ratio less than 16, in general, a combustion chamber has a low compression ratio and a maximal temperature becomes low when increased in temperature during compression. This allows the engine to minimize NOx emission. In contrast, the engine has deteriorated ignitability, causing a probability to occur with an increase in PM (Particulate Matters).

Under such an operating status, heating the glow plugs 1 at temperatures above 1100° C. enables ignitability to be improved. This can simultaneously address antinomy tasks of minimizing NOx emission and suppressing the occurrence of PM.

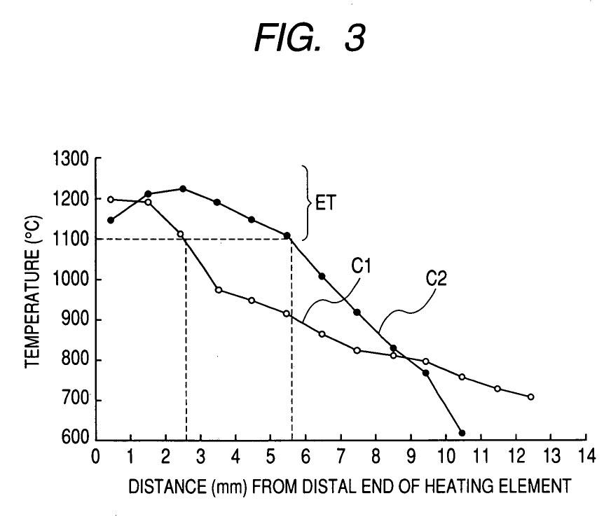

FIG. 3 is a graph showing a difference in temperature distributions of the glow plug, implementing the present invention, and the glow plug of the related art measured at various measuring points using a radiation thermometer with an emissivity of E=1 and a measuring circle φ of 0.5.

In FIG. 3, reference to “ET” represents an effective temperature of the heating element 100. A curve C1 represents a temperature distribution pattern of the glow plug shown as Comparative Example and a curve C2 represents another temperature distribution pattern of the glow plug implementing the present invention.

With the related art glow plug representing Comparative Example shown in FIG. 3, a heating section has an effective heating region ET, marking a temperature above 1100° C. effective for improving ignitability, which remains in a length less than 3 mm from a distal end of the heating section.

On the contrary, with the glow plug 1 of the present embodiment, the heating section 10 has an effective heating region ET, marking the temperature above 1100° C. effective for improving ignitability, which is greater than 5 mm from a distal end of the heating section 10.

Accordingly, the glow plug 1 of the present embodiment has a widened effective heating area (effective temperature area) that is higher in temperature than 1100° C., providing further stability in ignitability.

Next, tests were conducted on the glow plug, implementing the present invention, and the glow plug of the related art for evaluating ignitability. These tests were conducted on initial resistance R20, heating resistance R1200 and a temperature coefficient of resistance R1200/R20 upon varying these parameters. In this case, R20 represents a resistance of the heating element at a temperature of 20° C., R1200 a resistance of the heating element at a temperature of 1200° C. and R1200/R20 a ratio of the R1200 to R20. Test results are summarized in Table 1.

TABLE 1

| | | | TEMPERATURE | |
|---|---|---|---|---|
| | | | COEFFICIENT | |
| | R20 | | of | |
| | (Ω) | R1200 (Ω) | RESISTANCE | STARTABILITY |
| EXAM. 1 | 0.30 | 1.20 | 4 | EXCELLENT |
| EXAM. 2 | 0.40 | 1.00 | 2.5 | EXCELLENT |
| EXAM. 3 | 0.50 | 1.25 | 2.5 | EXCELLENT |
| EXAM. 4 | 0.60 | 1.20 | 2.0 | EXCELLENT |
| COMPAR. | 0.20 | 0.80 | 4.0 | NO STARTUP |
| EXAM. 1 | | | | (STARTER WITH |
| | | | | NO ROTATION) |
| COMPAR. | 0.20 | 1.00 | 5.0 | NO STARTUP |
| EXAM. 2 | | | | (STARTER WITH |
| | | | | NO ROTATION) |
| COMPAR. | 0.25 | 1.00 | 4.0 | NO STARTUP |
| EXAM. 3 | | | | (STARTER WITH |
| | | | | SLOW |
| | | | | ROTATION) |
| COMPAR. | 0.50 | 2.00 | 4.0 | NO STARTUP |
| EXAM. 4 | | | | (GLOW |
| | | | | TEMPERATURE |
| | | | | BELOW 1100° C.) |
| COMPAR. | 0.60 | 1.50 | 2.5 | NO STARTUP |
| EXAM. 4 | | | | (GLOW |
| | | | | TEMPERATURE |
| | | | | BELOW 1100° C.) |

With the glow plugs of Examples 1 to 4, a rush current was minimized to a relatively low value less than 45 A with a starter of the engine being immediately caused to rotate. In this case, the heating element 100 raised to a temperature of 1200° C. with heating resistance R1200 marking a value less than 1.3Ω and each glow plug had a power consumption less than 70 W, resulting in a success of immediate startup of the engine within 30 seconds after commencing cranking operation.

With the glow plugs of the related art in Comparative Examples 1 and 2, a large rush current occurred through the glow plugs with a resultant shortage in electric power being supplied to the starter of the engine. This resulted in incapability of rotating the starter with an unsuccess in startup of the engine.

With the glow plug of the related art in Comparative Example 3, the engine successfully started up. However, a large rush current flowed through the glow plug with a resultant shortage in electric power being supplied to the starter of the engine. When this took place, the starter rotated at a slow speed causing a long period of time to take for startup of the engine.

With the glow plugs of the related art in Comparative Examples 4 and 5, a rush current was minimized to a low value less than 27 A to enable the starter to rotate. However, a heating resistance was large causing a shortage of electric power with a resultant incapability of increasing a glow temperature to a value above 1100° C. Also, startup of the engine was unsuccessful.

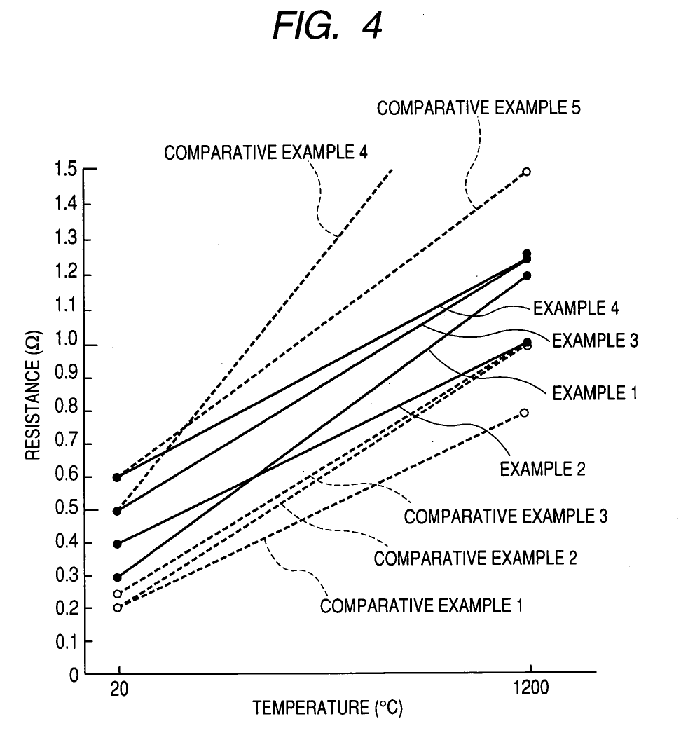

FIG. 4 is a graph showing measured results on heating temperatures and resistances of the glow plugs of Examples 1 to 4 and the glow plugs of the related art in Comparative Examples 1 to 5. A technical knowledge is obtained on the ground of the test results on the glow plugs of Examples 1 to 4 in which the engine had successes in startup.

That is, the heating element 100 of the glow plug 1 lies in a region A that satisfies the relationship in electrical characteristics including:

(a) initial resistance R20 equal to or greater than 0.3Ω and equal to or less than 0.65Ω;

(b) heating resistance R1200 equal to or greater than 0.7Ω and equal to or less than 1.3Ω; and

(c) temperature coefficient of resistance R1200/R20 laying in a value equal to or greater than 2.0 and equal to or less than 4.0.

With the heating element 100 having such electrical characteristics, a heat develops in the heating element 100 at a temperature above 1200° C. with power consumption less than 70 W and a rush current minimized to a value less than 45 A when applied with electric power.

Thus, with the glow plug 1 of the present embodiment, the heating element 100 can have a surface temperature kept at a value above 1100° C., thereby making it possible to reliably start up the engine.

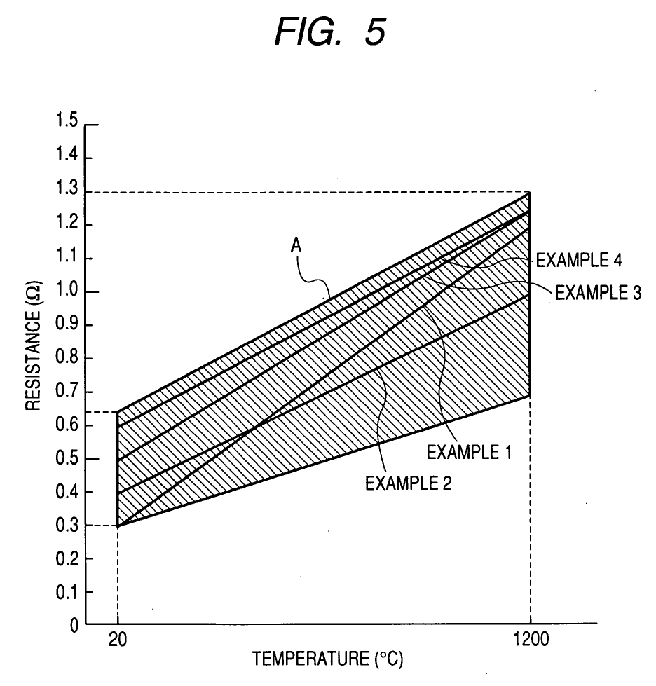

FIG. 5 shows a graph representing the relationships between resistances of the heating element 100 and the resulting temperatures covering the region A.

The heating elements 100 were made of materials blended in given blending ratios as listed below in Table 2. With the glow plugs 1 of Examples 1 to 4 and the glow plugs of the related art in Comparative Examples 1 to 5, the heating elements were made of ceramic composed of a principal composition of silicon nitride (Si₃N₄) and including tungsten carbide (WC) and silicon carbide (SiC) in varying blending ratios. Also, yttria (Y₂O₃) was used as a sintering agent.

TABLE 2
COMPOSITIONS OF HEATING ELEMENTS
IN VARIOUS EXAMPLES

(By wt %)

| | Si₃N₄ | WC | SiC | Y₂O₃ |
|---|---|---|---|---|
| EXAM. 1 | 35 | 45 | 10 | 10 |
| EXAM. 2 | 20 | 45 | 10 | 10 |
| EXAM. 3 | 25 | 40 | 25 | 10 |
| EXAM. 4 | 20 | 40 | 30 | 10 |
| COMPAR. | 40 | 40 | 10 | 10 |
| EXAM. 1 | | | | |
| COMPAR. | 50 | 40 | — | 10 |
| EXAM. 2 | | | | |
| COMPAR. | 43 | 47 | 10 | 10 |
| EXAM. 3 | | | | |
| COMPAR. | 50 | 30 | 10 | 10 |
| EXAM. 4 | | | | |
| COMPAR. | 35 | 30 | 25 | 10 |
| EXAM. 5 | | | | |

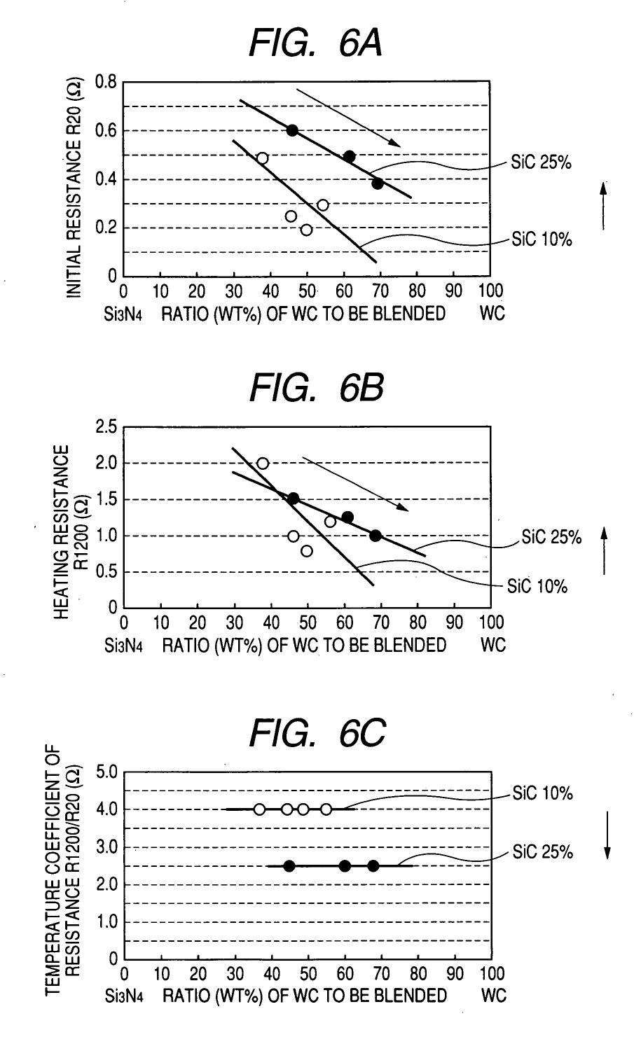

FIGS. 6A to 6C, FIGS. 7A and 7B and FIGS. 8A to 8C collectively show the relationships between the blending ratios, shown in Table 2, and initial resistance R20, heating resistance R1200 and temperature coefficient of resistance R1200/R20.

As shown in FIGS. 6A and 6B, if a ratio of tungsten carbide (WC) increased in the relationship between silicon nitride (SiC) and tungsten carbide (WC), initial resistance R20 and heating resistance R1200 decreased. As shown in FIG. 6C, temperature coefficient of resistance R1200/R20 remained fixed regardless of variation in a quantity of tungsten carbide (WC).

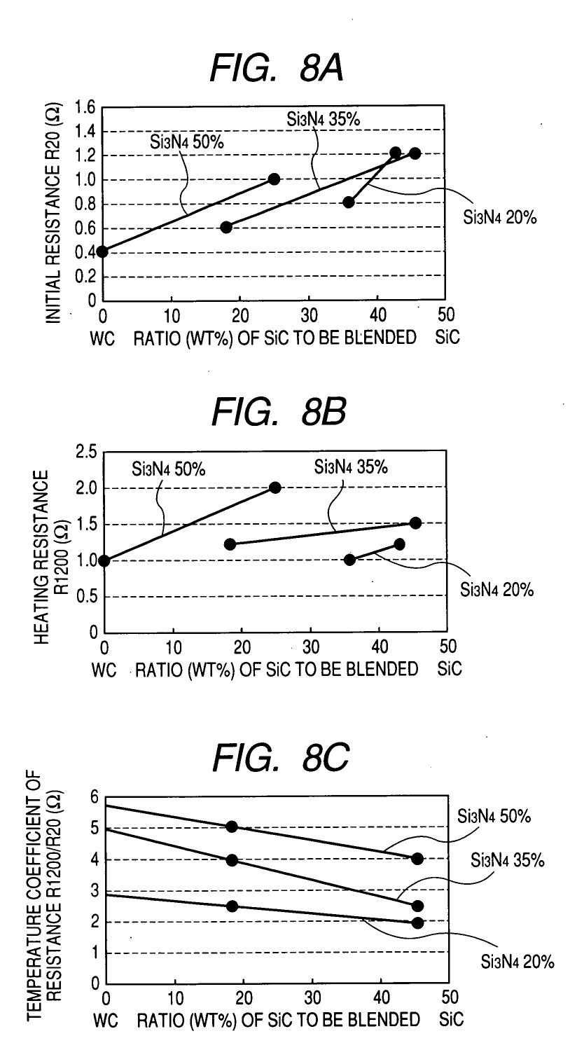

As shown in FIGS. 8A to 8C, further, if a ratio of silicon carbide (SiC) increased in the relationship between silicon nitride (Si₃N₄) and tungsten carbide (WC), initial resistance R20, heating resistance R1200 and temperature coefficient of resistance R1200/R20 decreased.

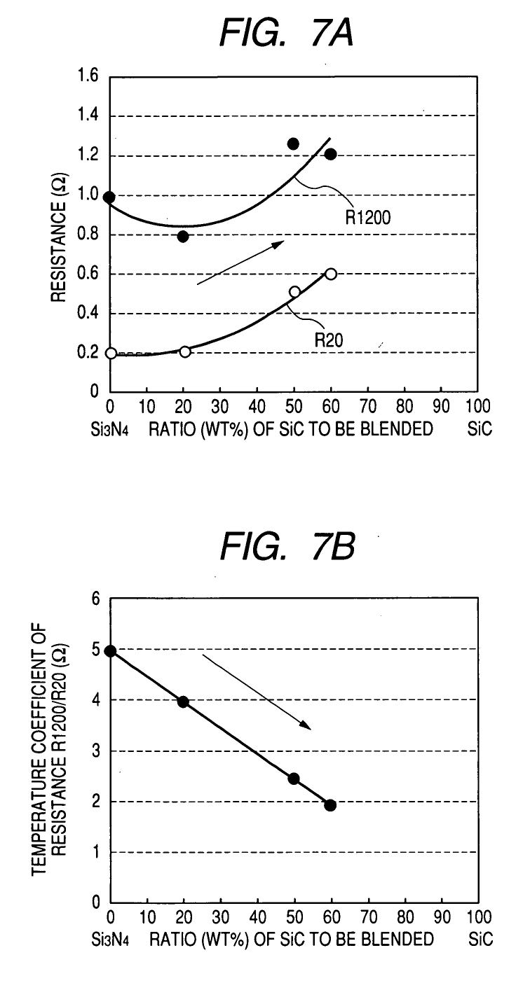

As shown in FIG. 7A, if a ratio of silicon carbide (SiC) increased in the relationship between silicon nitride (Si₃N₄) and tungsten carbide (WC), both of initial resistance R20 and heating resistance R1200 had a tendency to increase.

As shown in FIG. 7B, if a ratio of silicon carbide (SiC) increased in the relationship between silicon nitride (Si₃N₄) and tungsten carbide (WC), temperature coefficient of resistance R1200/R20 decreased.

As shown in FIGS. 8A and 8B, if a ratio of silicon carbide (SiC) increased in the relationship between silicon nitride (Si₃N₄) and tungsten carbide (WC), both of initial resistance R20 and heating resistance R1200 increased.

As shown in FIG. 8C, if a ratio of silicon carbide (SiC) increased in the relationship between silicon nitride (Si₃N₄) and tungsten carbide (WC), temperature coefficient of resistance R12200/R20 decreased.

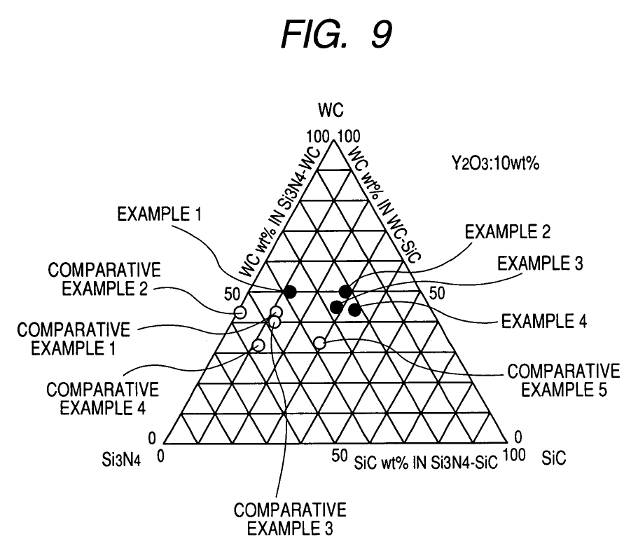

FIG. 9 shows the blending ratios of ceramic materials, listed in Table 2, in a ternary phase diagram of silicon nitride (Si₃N₄), tungsten carbide (WC) and silicon carbide (SiC). In the ternary phase diagram shown in FIG. 9, filled circles “” represent the blending ratios of components forming the heating elements of the glow plugs of Examples 1 to 4 and empty circles “∘” represent the blending ratios of components forming the heating elements of the glow plugs of Comparative Examples 1 to 4.

The proportions of ceramic raw materials to be mixed can be changed in varying blending ratios in a range close proximity to those plotted in the filled circles “” in FIG. 9. In this case, the parameters such as initial resistance R20, heating resistance R1200 and temperature coefficient of resistance R1200/R20 lie in the region A shown in FIG. 5. Even with such blending ratios, it can be expected that the glow plug of the present embodiment has similar advantageous effects.

With the glow plugs of Examples 1 to 4, further, while the heating element is made of ceramic containing silicon nitride, tungsten carbide, silicon carbide and yttrium oxide, a whole of or a part of silicon carbide may be replaced by rhenium or molybdenum.

Further, a whole of or a part of tungsten carbide may be replaced by molybdenum bisilicate.

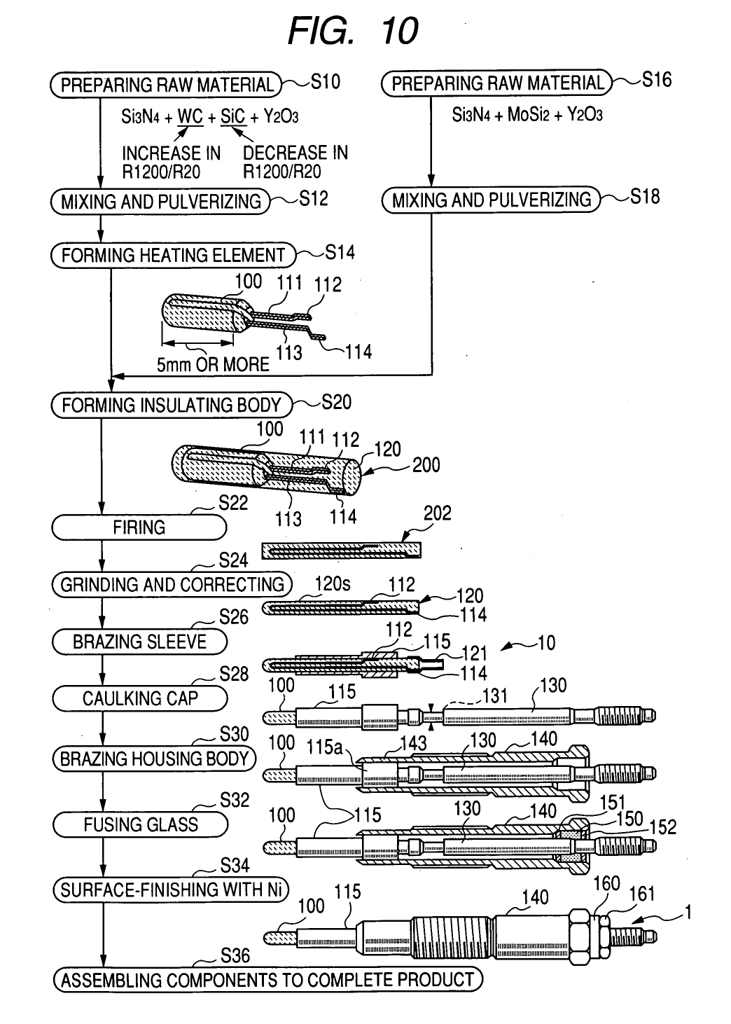

Now, a method of manufacturing the glow plug of the present invention will be described below in detail with reference to FIG. 10.

First in step S10, silicon nitride (Si₃N₄), tungsten carbide (WC), silicon carbide (SiC) and yttrium oxide (Y₂O₃) are weighed and blended in a given blending ratio to provide a blend.

Next in step S12, the blend is mixed and pulverized, thereby obtaining a heating element raw material.

In succeeding step S14, the heating element raw material is formed in a substantially U-shaped green heating element 100 (with, for instance, a total length of 12 mm and an outer diameter φ of 3.3 mm) using forming means such as, for instance, injection and printing, etc. Thereafter, the grounding lead wire 111, made of stainless steel having the grounding terminal portion 112, and the power supply lead wire 113, having the power supply terminal portion 114, are inserted to the inside of the green heating element 100.

In step S16, silicon nitride (Si₃N₄), molybdenum bisilicate (MoSi₂) and yttrium oxide (Y₂O₃) are prepared to provide a blend in a given blending ratio. In step S18, the blend is mixed and pulverized, thereby obtaining insulating support body raw material for forming the insulating support body 120.

In subsequent step S20, the insulating support body 120 is integrally formed with the green heating element 100 in a substantially cylindrical shape so as to cover a whole of the heating element 100. Under such a state, the grounding lead wire 111 and the power supply lead wire 113 are embedded inside the insulating support body 120, thereby forming a compact 200.

In next step S22, the resulting compact 200 is then subjected to a firing process to obtain a fired compact 202. In subsequent step S24, the compact 202 is grounded to correct an outer diametric dimension to a given size to match an inner diameter of the metallic sleeve member 111 with the grounding terminal 112 and the power supply terminal 114 exposed to an outer surface 120s of the insulating support body 120.

In step S26, the insulating support body 120, in which the grounding lead wire 111, the power supply lead wire 113 and the heating element 100 are integrally embedded, is inserted to the metallic sleeve member 115. Thereafter, the grounding terminal 112 and the metallic sleeve member 115 are connected to each other by brazing.

Then, the power supply terminal 114, exposed from the metallic sleeve member 115, is inserted to one end of the connecting cap 121, after which the power supply terminal 114 and the connecting cap 121 are connected to each other by brazing.

With various steps implemented in such a way, the heating element 100 is completed.

In next step S28, the cap fitting segment 131 of the intermediate power supply connecting rod 130, prepared in a separate step, is fitted to the small-diameter base end 121a of the connecting cap 121. Thereafter, the connecting cap 121 is caulked to allow the heating element 100 to be tightly connected to the intermediate power supply connecting rod 130 via the connecting cap 121.

In step S30, the intermediate power supply connecting rod 130 is inserted to the housing body 140 with the base end portion 115a of the metallic sleeve member 115 fitted to the element holder portion 143. Subsequently, the base end portion 115a of the metallic sleeve member 115 is brazed to and fixed to the element holder portion 143 of the housing body 140.

In step S32, the insulating seal members 151, 152 are inserted to an internal bore 140d of the base end portion 140c of the housing 140 in an axially spaced relationship. Then in step S34, the sealant 150, filled between the insulating seal members 151, 152, is fused to provide a tightly sealing effect. This allows the base end portion 140c of the housing 140 to support the base end portion 130b of the intermediate power supply connecting rod 130 in an electrically insulating capability with the sealing effect.

In succeeding step S34, the housing body 140 and the metallic sleeve member 115 are finished in surface treatment with Ni.

Subsequently, in step S36, the insulating seal member 160 is placed on the end face of the hexagonal head 142, upon which the nut 161 is screwed onto threaded portion 132, thereby tightly holding the intermediate power supply connecting rod 130 with the housing body 140 in a fixed place.

Thus, the glow plug 1 of the present invention is completed in such a manner set forth above.

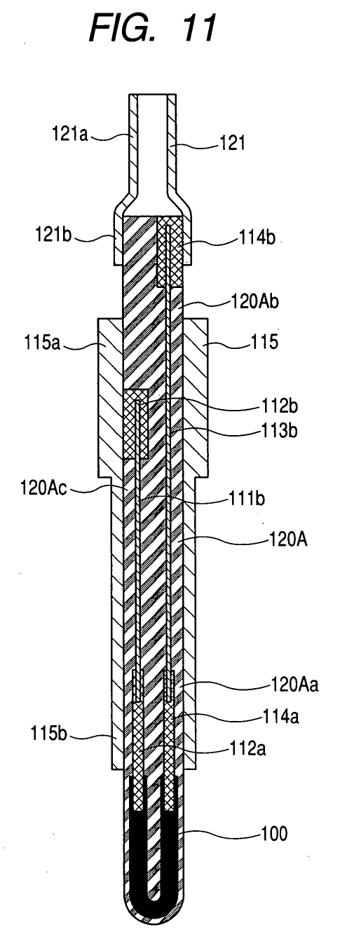

FIG. 11 is a cross sectional view showing a modified form of the heating element 100 of the glow plug 1 of the embodiment according to the present invention.

With a glow plug 1A of this modification, an insulating support body 120A has a leading end portion 120Aa, embedded with axially extending electrically conductive ceramic connecting portions 112a, 114a, a base end portion 120Ab, embedded with an axially extending electrically conductive ceramic connecting portion 114b made of the same material as that of the electrically conductive ceramic connecting portion 114a, and an intermediate portion 120Ac embedded with an electrically conductive ceramic connecting portion 112b made of the same material as that of the electrically conductive ceramic connecting portion 112a.

With the insulating support body 120A shown in FIG. 11, the electrically conductive ceramic connecting portions 112a, 114a are completely embedded inside the insulating support body 120A with the electrically conductive ceramic connecting portions 112b, 114b being exposed to a surface of the insulating support body 120A.

Under such a structure of the insulating support body 120A, a grounding lead wire 111b, made of tungsten, has one end, connected to the electrically conductive ceramic connecting portion 112b, and the other end connected to the electrically conductive ceramic connecting portion 112a. Likewise, a power supply lead wire 113b, made of tungsten, has one end, connected to the electrically conductive ceramic connecting portion 114b, and the other end connected to the electrically conductive ceramic connecting portion 114a. Thus, the other ends of the grounding lead wire 111b and the power supply lead wire 113b are connected via the electrically conductive ceramic connecting portions 112a, 114a, respectively, to both ends of the heating element 100 embedded in the leading end portion 120Aa in the substantially U-shape configuration. In addition, one end of the grounding lead wire 111b is grounded to the base end portion 115a of the metallic sleeve member 115 via the electrically conductive ceramic connecting portion 112b. Further, one end of the power supply lead wire 113b is connected to a large-diameter leading end portion 121b of the connecting cap 121.

The electrically conductive ceramic connecting portions 112a, 12b, 114a, 114b, made of electrically conductive ceramic with electrical resistance lower than that of the heating element 100, may preferably include materials including silicon nitride and tungsten carbide.

Under a circumstance where the heating element 100 is directly connected to the pair of lead wires 111b, 113b as shown in FIG. 11, there is a probability in which heats develop in the lead wires at associated junctions thereof. When this occurs, thermal stresses act on the associated junctions due to a difference in thermal expansion coefficient between the heating element 100 and the electrically conductive ceramic connecting portions 111b, 113b, causing disconnection to occur in the lead wires.

With the structure of the insulating support body 120A shown in FIG. 11, intervening the electrically conductive ceramic connecting portions 112a, 114a at locations between the heating element 100 and the pair of lead wires 111b, 113b enables the suppression of heat development at the associated junctions for thereby minimizing the occurrence of thermal stresses.

While the specific embodiments of the present invention have been described in detail, the present invention is not limited to the particularly illustrated structures of the gas sensors of the various embodiment set forth above provided that the measuring gas side covers achieve the task of the present invention. It will be appreciated by those skilled in the art that various modifications and alternatives to those details could be developed in light of the overall teachings of the disclosure.

For instance, the specific composition of the heating element is not limited to those disclosed the illustrated embodiments and the heating element may preferably include various raw materials that can be suitably selected to fall in a range to satisfy initial resistance R20, heating resistance R1200 and temperature coefficient of resistance R1200/R20 as set forth above.

Further, while the switching circuit mentioned above may preferably include power semiconductor elements such as MOSFET (Metal Oxide Semiconductor Field Effect Transistor), IGBT (Insulation Gate Bipolar Transistor), etc., the present invention is not limited to such semiconductor switching elements.

What is claimed is:

1. A glow plug for use in an engine to heat a combustion chamber, the glow plug comprising:
a heating section including:
a ceramic heating element operative to develop a heat when supplied with an electric power;
a ceramic insulating support body carrying thereon the ceramic heating element; and
a pair of lead wires, supported with the ceramic insulating support body, which have external ends exposed to a surface of the ceramic insulating support body for supplying the electric power to the heating element;
wherein the heating element has a positive temperature coefficient of resistance and lies in a region satisfying the relationship expressed as parameters including:
(a) initial resistance R20 equal to or greater than 0.3Ω and equal to or less than 0.65Ω;
(b) heating resistance R1200 equal to or greater than 0.7Ω and equal to or less than 1.3Ω; and
(c) temperature coefficient of resistance R1200/R20 equal to or greater than 2.0 and equal to or less than 4.0,
where the initial resistance R20 represents a resistance at a temperature of 20° C.;
the heating resistance R1200 represents a resistance at a temperature of 1200° C.; and
the temperature coefficient of resistance R1200/R20 represents a ratio between the heating resistance R1200 and the initial resistance R20.

2. The glow plug according to claim 1, wherein:
the heating element may preferably have a surface temperature above 1100° C., when applied with a rated voltage, which is measured with a radiation thermometer with a radiation rate of E=1 and a measuring circle of φ0.5.

3. The glow plug according to claim 2, wherein:
the heating element has an effective area exceeding a length of 5 mm from a distal end of the heating element wherein the surface temperature of the heating element exceeds a temperature of 1100° C. when applied with the rated voltage.

4. The glow plug according to claim 2, wherein:
the heating element is made of ceramic composed of a principal component of silicon nitride and including at least one kind of tungsten carbide and molybdenum bisilicate and at least one kind of silicon carbide, rhenium and molybdenum.

5. The glow plug according to claim 1, wherein:
the insulating support body is made of ceramic composed of a principal component of silicon nitride and including molybdenum bisilicate.

6. The glow plug according to claim 1, wherein the heating section further comprises:
an electronic control unit for supplying a pulse signal depending on a status of the engine; and
a glow plug drive unit including switching circuits for controllably turning on and off the glow plug in response to the pulse signal delivered from the electronic control unit;
wherein the electronic control unit regulates a duty cycle of the pulse signal to apply a root-mean-square voltage to the glow plug in a pulse width modulation for thereby controlling a temperature of the glow plug.

7. The glow plug according to claim 1, wherein:
the engine is set to have a compression ratio ε less than a value of 16.

8. The glow plug according to claim 1, wherein the heating section further comprises:
a housing body fixedly supporting the insulating support body and adapted to be grounded to the engine body;
a power supply member fixedly mounted in the housing body and having a power supply terminal for supplying the electric power to the heating element;
a heating element holder portion formed on the housing body and fixedly holding the heating element; and
a metallic sleeve member intervening between the heating element holder portion and the insulating support body;
wherein one of the pair of lead wires is grounded to the engine head through the housing body and the heating element holder portion.

9. The glow plug according to claim 8, wherein the heating section further comprises:
a connecting cap intervening between the power supply member and the heating element to deliver the electric power thereto.

10. The glow plug according to claim 9, wherein:
the pair of lead wires has one end exposed to a surface of the insulating support body in electrical contact therewith and the other end connected through the connecting cap to the power supply member.

11. The glow plug according to claim 9, wherein:
the insulating support body has a leading end, embedded with a pair of electrically conductive ceramic portions through which one ends of the pair of the lead wires are connected to both ends of the heating element, a base end embedded with an electrically conductive ceramic portion the other end of one lead wire is connected, and an intermediate portion embedded with an electrically conductive ceramic portion, wherein the electrically conductive ceramic portion of the base end portion is held in electrically contact with the connecting cap and the electrically conductive ceramic portion of the intermediate portion is held in electrical contact with the metallic sleeve member.

12. A method of manufacturing a glow plug for use in an engine to heat a combustion chamber, the method comprising the steps of:
preparing a green ceramic heating element;
placing a power supply lead wire, having a power supply terminal, and a grounding lead wire, having a grounding terminal, in the green ceramic heating element;
forming a green ceramic insulating support body so as to cover the green ceramic heating element and the power supply lead wire and the grounding lead wire;
firing the green ceramic insulating support body to obtain the fired ceramic insulating support body carrying thereon a heating element operative to develop a heat when applied with an electric power through the power supply lead wire;
grinding the fired ceramic insulating support body to form a ceramic insulating support body with the power supply terminal and the grounding terminal exposed to a surface of the ceramic insulating support body; and
assembling the ceramic insulating support body to a housing body to form the glow plug with the power supply terminal of the heating element connected to an external power supply terminal in a manner electrically insulated from the housing body while electrically connecting the grounding terminal of the heating element to the housing body to be grounded to the engine;
wherein the heating element has a positive temperature coefficient of resistance and lies in a region satisfying the relationship expressed as parameters including:
(a) an initial resistance R20 equal to or greater than 0.3Ω and equal to or less than 0.65Ω;
(b) a heating resistance R1200 equal to or greater than 0.7Ω and equal to or less than 1.3Ω; and
(c) a temperature coefficient of resistance R1200/R20 equal to or greater than 2.0 and equal to or less than 4.0,
where the initial resistance R20 represents a resistance at a temperature of 20° C.;
the heating resistance R1200 represents a resistance at a temperature of 1200° C.; and
the temperature coefficient of resistance R1200/R20 represents a ratio between the heating resistance R1200 and the initial resistance R20.

13. The method of manufacturing a glow plug for use in an engine according to claim 12, wherein:
the green ceramic heating element is composed of silicon nitride, tungsten carbide, silicon carbide and yttrium oxide which are mixed in a given blending ratio to achieve the initial resistance R20, the heating resistance R1200 and the temperature coefficient of resistance R1200/R20.

14. The method of manufacturing a glow plug for use in an engine according to claim 13, wherein:
a whole of or a part of silicon carbide is substituted with at least one element selected from rhenium and molybdenum.

15. The method of manufacturing a glow plug for use in an engine according to claim 13, wherein:
a whole of or a part of tungsten carbide is substituted with molybdenum bisilicate.
